(19) United States
(12) Patent Application Publication
(10) Pub. No.: US 2005/0025348 A1
(43) Pub. Date: Feb. 3, 2005

(54) Method of and apparatus for processing image data

(76) Inventors: Kirk S. Tecu, Greeley, CO (US); William R. Haas, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/629,161

(22) Filed: Jul. 29, 2003

(51) Int. Cl. G06K 9/00

(52) U.S. Cl. 382/128

(57) ABSTRACT

A method of performing a designated action comprises the processing image data representative of an image recorded on a medium comprising identifying intent information contained within said image data; processing the intent information to identify the action; and initiating processing of the image to perform the designated action. A computer program product having a computer readable medium having computer program logic recorded thereon, the computer program product comprising code for processing image data and identifying within said image data at least one portion representing an instruction for further processing said image data, and code for initiating said further processing said image data in accordance with said instruction.

### BACKGROUND

A user typically has to perform several steps or functions in order to process a hardcopy of a document. For example, if the user desires to copy, save or e-mail a hardcopy document, the user first has to convert the hardcopy document into a digital format, such as an image or word processing file format. Then the user has to manipulate or process the digital file, for example, by attaching it to an e-mail message or sending the file to a printer. These steps may require the user to use more than one device, such as a scanner, a Personal Computer (PC) and a printer, and more than one software application, such as scanning software, word processing software, Optical Character Recognition (OCR) software and messaging software.

The user must manually interact with each of these devices and applications in order to process the hardcopy document. For example, to send information in a paper document via e-mail to a user, a user has to scan the document, OCR the image, and then save the document as a word processing file before attaching the document to an e-mail message.

### SUMMARY OF THE INVENTION

In one embodiment, a method comprises processing image data recorded on a medium, identifying intent information contained within said image data, processing the intent information to identify a specific action associated with intent information, and initiating processing of the specific action.

In another embodiment, a computer program product having a computer readable medium having computer program logic recorded thereon, the computer program product comprises code for processing image data and identifying within said image data at least one portion representing an instruction for further processing said image data, and code for initiating said further processing said image data in accordance with said instruction.

In another embodiment, a method of processing a document comprises representing said document as image data, locating, within said image data, an area of said document containing intent information, identifying an action indicated by said intent information, and initiating processing of said document consistent with said action.

In an additional embodiment, a data processing system comprises means for representing a document as image data, means for locating, within said image data, an area of said document containing intent information, means for identifying an action indicated by said intent information, and means for initiating processing of said document consistent with said action.

### BRIEF DESCRIPTION OF THE DRAWINGS

FIG. 1 is a block diagram of a data processing system suitable for practicing methods and systems consistent with an embodiment of the present invention;

FIGS. 2A and 2B are examples of media suitable for practicing methods and systems consistent with an embodiment of the present invention;

FIG. 3 includes examples of symbols suitable for practicing methods and systems consistent with an embodiment of the present invention;

FIG. 4 is a block diagram of a computer according to an embodiment of the invention as depicted in FIG. 1;

FIG. 5 is a flow chart of steps performed when scanning media and reading embedded information consistent with exemplary methods and systems of the present invention; and

FIG. 6 is a flow chart of steps performed when scanning media and reading embedded information consistent with exemplary methods and systems of the present invention.

### DETAILED DESCRIPTION

Hardcopy documents and other media may be converted into a digital format by scanning the document or media using an optical scanner. Scanners are devices that detect information, such as text or illustrations, that is printed on documents or other media. The scanner transforms the printed information into a suitable digital form for computer use. To read the information, the optical scanner may first digitize the image on the media. The scanner may create a digital “bitmap” of the image that can be stored in a file, displayed on a computer screen, or manipulated by other software programs, such as a printing application, a messaging application, an OCR application or a photo editing program. Optical scanners may be stand-alone devices, such as flatbed scanners, or they may be incorporated into other devices, such as an All-In-One (AIO) device that can scan, print, copy and/or fax documents.

The present invention allows a computer system, or other processor-based system, to process a document according to specific intent information that is embedded in the document. The intent information on the document determines how the document is processed. To perform an action on a document, the user first inputs the document or other medium into the computer. This step may be accomplished by scanning, as discussed above, or by other methods, such as opening a digital file on a disk or hard drive or receiving the document via an e-mail message or facsimile. The computer system analyzes the intent information on the document and determines an appropriate processing for the document based on the intent information.

The present invention reduces the extent of manual actions required by the user and allows the user to embed intent information onto the document or media. The intent information represents an intended or desired action that the user wishes to perform on the document. The embedded intent information may be captured and processed by a computer using processing software. The embedded intent information enables a user to perform an action with little to no manual intervention. In other words, a computer system can read the intent information on the document and automatically perform the intent without any further action by the user.

Using embedded intent information to input commands reduces the time that a user has to spend processing the document. The embedded information may be included on or in the original document, or the user may hand annotate the media, for example, within a designated intent area. The intent information indicates action(s) that the computer system is to perform on the document or on the information contained on some other media.

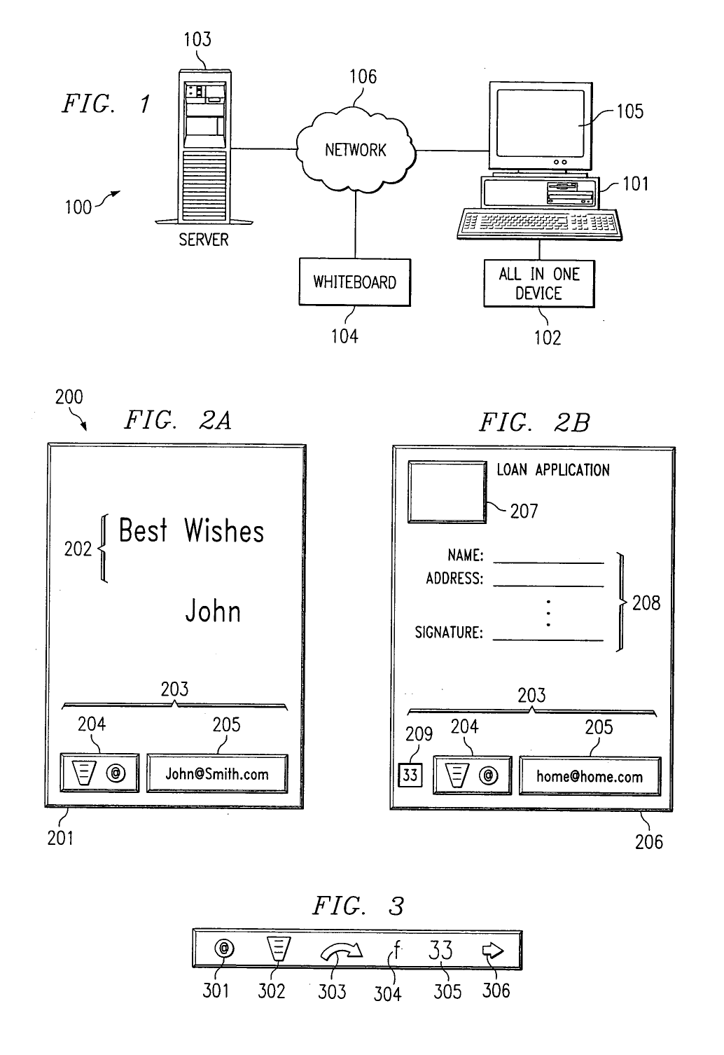

FIG. 1 depicts one example of a data processing system 100 suitable for use with methods, apparatus, and systems consistent with the present invention. System 100 includes computer 101, AIO device 102, server 103, electronic whiteboard 104, and electronic display screen 105 that are all connected through network 106. Computer 101 may communicate with AIO device 102 using an input/output port, such as a Universal Serial Bus (USB) port (not shown), on computer 101.

AIO device 102 may be used to scan information contained on media or documents. Alternatively, a scanner or other device may be used to capture or otherwise retrieve the information on a document. In one embodiment, AIO 102 identifies and processes the embedded intent information located within the media. Server 103 receives, via computer 101, information from media that is scanned by AIO device 102. Server 103 may send this information in the form of an e-mail message to other computers or may store the captured information.

An alternative method for inputting information is by drawing on electronic whiteboard 104. The information drawn on electronic whiteboard 104 may include intent information that can be processed as embedded intent information according to the present invention. The information from electronic whiteboard 104 may be sent to computer 101 for further processing. For example, intent information may be written on whiteboard 104 that causes computer 101 to capture the information on written whiteboard 104 and to display that information on screen 105 or to print that information on AIO device 102.

FIG. 2A depicts exemplary medium 200 suitable for use with methods and systems consistent with the present invention. Medium 201 contains content area 202 and intent information area 203. Content area 202 is a location where a scanner, AIO device 102 or other device may capture content to be processed. Intent area 203 contains icon area 204 and text area 205. Icon area 204 may contain at least one icon that indicate a desired action (i.e., intended action or processing) to be performed with the medium and/or with the content area. For example, icon area 204 includes a print or e-mail icon, as shown in FIG. 2A. Text area 205 may contain additional intent information that is associated with at least one icon located within icon area 204. For example, text area 205 may include an e-mail address, file location or electronic whiteboard name.

In one embodiment, scanning software may include an application that recognizes the information within intent area 203 as an indication that certain processing should be performed on medium 201. For example, icon area 204 may contain an e-mail icon and text area 205 may contain the text “john@smith.com.” The e-mail icon indicates that computer 101 should electronically transmit (e.g., e-mail) the content located within content area 202 to the recipient associated with the e-mail address in text area 205 (i.e. john@smith.com). It will be understood that medium 201 may be a pre-printed form with designated areas for content information (202) and for intent information, such as icons (204) and text (205). Alternatively, medium 201 may be a completely hand-written message with, for example, hand-drawn boxes 204, 205 at the bottom for the icon and text-intent information. Of course, other techniques for applying intent information according to the present invention may be used, such as application of preprinted pressure sensitive labels to media indicative of intent, if desired. Further, the locations of content area 202 and intent area 203 may vary so that any area of medium 200 may contain content or intent information. The content and/or intent information may be offset from other information using, for example, preprinted or hand-drawn boxes.

FIG. 2B is another example of media that is useable with the present invention. Medium 206 may contain blank area 207, content area 208, intent area 203 and form area 209. Blank area 207 is an available location where AIO device 102 or other printer device may print information. Form area 209 is a location that may contain various information useful according to the present invention, such as a media profile identifier. An icon in icon area 204 may indicate the presence of information in form area 209. For example, if there is a print icon in icon area 204, then there may also be corresponding information in form area 209, such as to provide a media profile with respect to medium 206.

In the illustrated embodiment, form area 209 contains a media profile identifier in the form of the number “33,” which may indicate a particular format of information upon medium 206 and/or certain information or images that AIO device 102 should print on medium 206. A media profile according to embodiments of the invention may provide a description of the document and/or associate a type of media with a particular software program to launch if the media type is detected. In such cases, scanning or editing software utilized according to one embodiment may automatically initiate an associated software program to requests specific information to be placed as additional information within the recognized media. For example, if medium 206 is a personal check, scanning or editing software may initiate money management software and request information, such as payee, amount, date and memo. The additional information may then be automatically inserted into medium 206, in the correct locations and/or in a desired format, during printing. Additional information regarding printing an image within blank area 207 may be found in commonly-assigned U.S. patent application Ser. No. 10/301,440, entitled DEVICE AND METHOD FOR SCANNING A FIRST IMAGE OF A DOCUMENT AND PRINTING A SECOND IMAGE ON THE DOCUMENT, filed Nov. 21, 2002, hereby incorporated by reference in its entirety.

The intent information may be indicated by placing it in boxes, as shown in FIGS. 2A and 2B, or by any number of alternative ways, such as highlighting, underlining, using a particular color or font, or placing the information in a designated area (e.g., at the bottom or top or in the margin of a document).

FIG. 3 illustrates exemplary icons that are suitable for use with the present invention. Icon 301 “@” may represent an e-mail icon. A user may use icon 301 to indicate to the processing software that the media or its content (202, 208) should be e-mailed to a particular e-mail recipient or uploaded to a particular Internet address.

Icon 302 may represent a print icon. A user may use icon 302 to indicate to the processing software that the media or its content should be printed. For example, if AIO device 102 scans and captures a document with print icon 302, the processing software will recognize print icon 302 as an instruction to print the scanned document. Accordingly, the user only has to scan the document, but does not have to manually save the scanned file, open the file in a word processing or graphics program and select a printer. Instead, the intent information processing software automatically prints the document upon recognizing print icon 302. Text area 205 may be used with print icon 302 to identify a particular printer, such as an attached, local printer or a network printer, or to indicate the type of paper that should be used by the printer.

Icon 303 may represent a retrieve icon. A user may use retrieve icon 303 to retrieve an image that is stored in a location identified by the user in text area 203. For example, text area 205 may indicate a file path for the stored image, such as “c:\retrieve area\file.jpg.” Retrieve icon 303 may be used to identify a path where an image or text can be found to print in blank space 207.

Alternatively, icon 303 may represent a save icon. A user may use icon 303 to instruct the system to save an image to a location identified by the user in text area 203. For example, text area 205 may indicate a file path and a filename to be assigned to the stored image, such as “c:\stroage area\file.jpg.” Icon 303 may itself instruct the system as to where the image should be stored. For example, the arrow (303) shown in FIG. 3 may indicate that the image should be stored to a default or predesignated location, such as a folder on a hard drive, a floppy drive, or a CD drive.

Icon 304 may represent a form designation icon. A user may use form designation icon to indicate the presence of media profile identifier information, which is illustrated by icon 305. Media profile identifier icon 305 may indicate a variety of information, such as the type of medium that is currently being scanned, the image that is to be printed within blank area 207, the form or format of the medium, the type of application software associated with the medium, or any other format or processing instructions.

Icon 306 may represent a push icon. A push icon may be used to initiate a transfer of information from a source system, e.g., “push” information from server 103 to another system.

It will be understood that many other symbols are possible and within the scope of the present invention, such as hand-annotated symbols, character symbols or symbols based on a standard, such as the ASCII standard. Also note that the icons in icon area 204 may be mutually exclusive and/or interrelated. For example, one icon may be an e-mail icon and a second icon may be a print icon or save icon. Also for example, one icon may be a retrieve icon and a second icon may be a print icon.

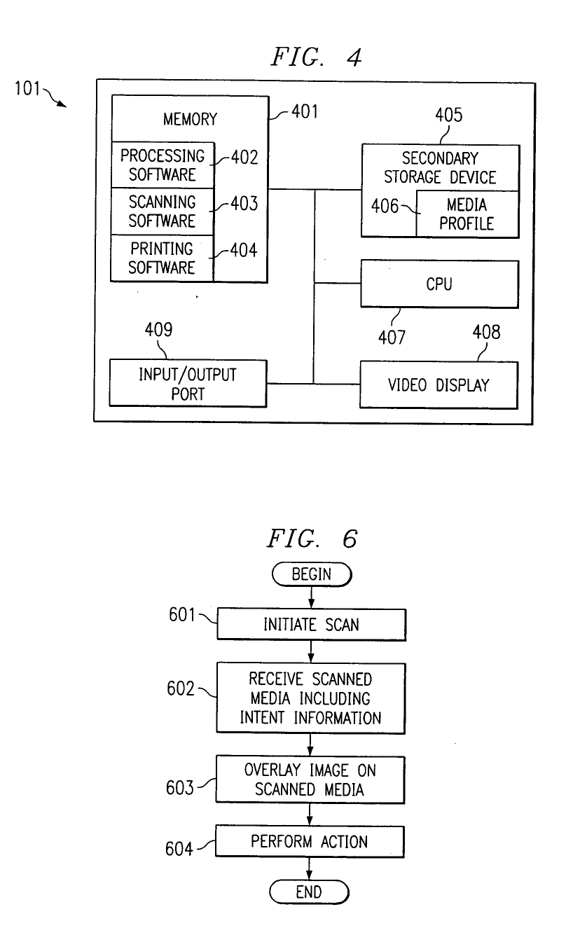

FIG. 4 is a diagram of one example computer system 101 that may be used to practice the present invention. Computer system 101 contains a memory 401, secondary storage device 405, Central Processing Unit (CPU) 407, video display 408 and input/output port 409. Memory 401 stores processing software 402, scanning software 403 and printing software 404. Processing software 402 may be used to process embedded intent information within medium 201 and to perform actions based on the intent information within intent area 203. Scanning software 402 may be used to control a device that scans medium 201. Printing software 404 may be used to control the printing of selected documents or content.

Secondary storage device 405 may contain media profiles 406 that are associated with form icon 209, for example, to identify a scanned media form. Input/output port 409 transmits information and receives information from AIO device 102 (e.g., print instructions). Input/output port 409 may be a RS-232 serial port or bi-directional IEEE 1388 compliant port, such as a parallel port or a Universal Serial Bus (USB) port. Although aspects of software 402, 403 and 404 are described as being stored in memory, note that these aspects may be stored on or read from a computer's readable media or other secondary storage devices, like hard disks, floppy disks, and CD-ROM, a carrier wave received from a network like the Internet, or other forms of Read Only Memory (ROM) or Random Access Memory (RAM).

FIG. 5 is a flow chart of an exemplary embodiment that illustrates scanning media and reading embedded information located within the media consistent with methods and systems of the present invention. In step 501, using scanning software 403, computer 101 initiates a scan of information contained on medium 201 by AIO device 102. Medium 201 may contain content located within content area 202 and intent information located within intent area 203. Once the medium is scanned, in step 502, computer 101 receives scanned information from AIO device 102. Note that information may also or instead come from other sources, such as whiteboard 104 or from any other device capable of receiving information. As such, device 102 is not limited to originating in an AIO device. For example, a user may create information and intent information on whiteboard 104. The information and intent information may be transmitted to computer 101 to be processed. Alternatively, computer 101 may receive intent information from secondary storage device 405.

In step 503, using processing software 402, if computer 101 determines intent information contains a “print” icon, computer 101 may use printing software 404 to perform a print action in step 504. Printing software 404 may transmit a print command and the associated print information, such as the content located within content area 202, to AIO device 102 or to a designated printer. Processing software 402 may determine the type of icon using an algorithm, such as a pattern recognition algorithm. For example, if processing software 402 determines an icon exists within intent area 203, processing software 402 may analyze icon area 204 using a pattern recognition algorithm.

In step 505, using intent information processing software 402, if computer 101 determines that the intent information located within intent area 203 is an “e-mail” icon, computer 101 may use processing software 402 to perform an e-mail action in step 506. Computer 101 may forward content located within content area 202 to an e-mail address located within user-supplied text area 205 by way of server 103. Server 103 may forward the entire e-mail message, including content to the identified recipient.

In step 507, using processing software 402, if computer 101 determines intent information located within intent area 203 is a “push” icon (306 of FIG. 3), computer 101 may use processing software 402 to perform a push action in step 508. A push action may be used to send data to a device without the device requesting the data. Computer 101 may push content located within content area 202 to a device located within user-supplied text area 205 capable of receiving push information. For example, computer 101 may push content to electronic whiteboard “WHITEBOARD1.” WHITEBOARD1 may be connected to network 106 and may display the content. Alternatively, information could be sent to another computer, uploaded to the Internet, or pushed to another electronic device.

In step 509, using processing software 402 if computer 101 determines intent information located within intent area 203 contains additional icons, computer 101 may perform appropriate additional action(s) in step 510. For example, icon area 204 may contain two icons, such as “retrieve” and “fax.” In such instances, computer 101 may first retrieve content from secondary storage device 405 based on information provided in user-supplied text area 205 and then send the retrieved content (for example, using a fax capable modem) to a facsimile number located within user-supplied text area 205.

In another example, using processing software 402, computer 101 may recognize information from medium 206 scanned by AIO device 102 and overlay an image stored within or identified by a media profile, such as stored within medial profile 406. A media profile is a description of the media and includes a notation as to where an additional image may be placed on the media. For example, if medium 206 are a loan application, computer 101 may include the loan officer's photograph on medium 206 within blank area 207 before e-mailing medium 206 to a group of loan applicants. For example, the present invention may be used with a system that scans a document and adds additional information to a printed version of the document, such as is described in co-pending, commonly assigned U.S. patent application Ser. No. 10/301,440 entitled “DEVICE AND METHOD FOR SCANNING A FIRST IMAGE OF A DOCUMENT AND PRINTING A SECOND IMAGE ON THE DOCUMENT,” filed in the U.S. Patent and Trademark Office on Nov. 21, 2002, the disclosure of which is hereby incorporated in its entirety.

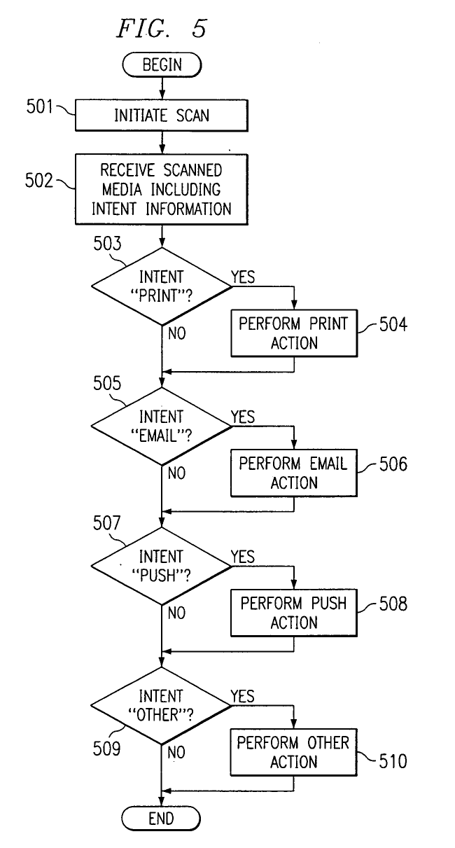

FIG. 6 is a flow chart of another exemplary embodiment that illustrates scanning and printing on the same media consistent with methods and systems of the present invention. In step 601, using scanning software 403, computer 101 may initiate a scan of medium 206. In step 602, computer 101 identifies the content located within content area 208 and intent information located within intent area 203. Using processing software 402, computer 101 recognizes medium 206 by matching a form icon located within form area 209 with a known media from media profiles 406 that are stored in secondary storage device 405. In step 603, computer 101 may overlay the image stored within media profile 406 onto medium 206 using the scanning and printing on the same media methodology, described above. In step 604, using processing software 402, computer 101 may perform an action based on the icon located within icon area 204 on medium 206. For example, if medium 206 are loan applications, computer 101 may include an image of the loan officer's photograph on medium 206 and e-mail medium 206 (including a new image in blank area 207) to a group of recipients.

The flow charts in FIGS. 5 and 6 illustrate exemplary processes used in embodiments of the invention. It will be understood that the invention is not limited to the number or order of the illustrated steps. The illustrated processes may be rearranged, may omit certain steps, or may add other steps (not shown). In another embodiment, a scanner may be used with scanning software 403 to digitize an image that is then automatically sent to another computer, facsimile machine, whiteboard or other electronic device. Note also that while the present invention has been discussed primarily using paper medium, other types of media including paper, cloth, plastics, photographs, or ceramic, may be used to capture images from or record images on.

1. A method, comprising:
processing image data recorded on a medium;
identifying intent information contained within said image data;
processing the intent information to identify a specific action associated with intent information; and
initiating processing of the specific action.

2. The method of claim 1 further comprising:
receiving content information associated with the medium,
wherein initiating processing further comprises performing the action using the content information.

3. The method of claim 1 wherein processing image data further comprises:
receiving the intent information embedded within the medium; and
converting the image recorded on the medium into said image data representing a digital image.

4. The method of claim 1 wherein processing image data further comprises receiving user-supplied text and an icon embedded within the medium, and processing the intent information further comprises determining a type of icon located within the intent information, and initiating processing of the image comprises performing the action using information contained on the media based on the type of icon located within the intent information.

5. The method of claim 1 further comprising:
determining a type of icon located within the intent information, wherein initiating processing of the image is responsive to said type of icon.

6. The method of claim 5 wherein said determining identifies said type of icon as a print icon, wherein initiating processing of the image comprises printing a content portion of said image.

7. The method of claim 1 wherein processing the intent information comprises:
selecting at lest one specific action from a plurality of different actions.

8. The method of claim 7 wherein the plurality of different actions is selected from the group consisting of printing, faxing and emailing.

9. The method of claim 1 wherein said processing image data further comprises:
identifying said medium; and
initiating software that requests information from a user, wherein the information is additional information to be placed upon said medium.

10. The method of claim 9 wherein said identifying the medium comprises:
searching media profiles stored in a secondary storage device.

11. A computer program product having a computer readable medium having computer program logic recorded thereon, the computer program product comprising:
code for processing image data and identifying within said image data at least one portion representing an instruction for further processing said image data; and
code for initiating said further processing said image data in accordance with said instruction.

12. The computer program product of claim 11 wherein said code for processing image data further comprises code for identifying content and intent regions of said image data, said instruction contained within a portion of said image data contained within said intent region.

13. The computer program product of claim 11 further comprising code identifying the instruction from an icon located on the image data.

14. The computer program product of claim 11 wherein said code for processing image data further comprises code for identifying separate content and intent regions of an input medium and extracting said at least one instruction from said intent region of said input medium.

15. The computer program product of claim 11 further comprising a media profile that associates a media with a particular software application to be used when a media profile icon is present in said image data.

16. A method of processing a document comprising:
representing said document as image data;
locating, within said image data, an area of said document containing intent information;
identifying an action indicated by said intent information; and
initiating processing of said document consistent with said action.

17. The method of claim 16 wherein representing comprises scanning a medium having embodied therein a visually perceptible image of the document so as to obtain said image data.

18. The method of claim 16 wherein locating comprises recognizing an image of an icon within said image data; and determining a type of said icon, said type of said icon designating said action.

19. The method of claim 16 wherein locating comprises recognizing, within said image data images of (i) a symbol designating said action and (ii) text present within a text area, said text comprising information associated with said action.

20. The method of claim 16 wherein locating comprises recognizing an image of a symbol designating said action, said symbol associated with at least one command selected from the group consisting of (i) print said document, (ii) e-mail said document, and (iii) save said document.

21. The method of claim 16 further comprising printing an image onto a blank area of said document.

22. The method of claim 16 wherein said locating comprises identifying a plurality of areas of said document and associating portions of said image data with said areas.

23. The method of claim 16 wherein said document comprises a content area separate from said area of said document containing said intent information, said locating comprising a step of recognizing a predetermined region of said document.

24. A data processing system comprising:
means for representing a document as image data;
means for locating, within said image data, an area of said document containing intent information;
means for identifying an action indicated by said intent information; and
means for initiating processing of said document consistent with said action.

25. The data processing system of claim 24 wherein said means for locating includes means for recognizing, within said image data, (i) a symbol designating said action and (ii) text present within a text area, said text including information associated with said action.
